(19) United States
(12) Patent Application Publication
(10) Pub. No.: US 2009/0250309 A1
(43) Pub. Date: Oct. 8, 2009

(54) Hydraulic Shift System for Power Transfer Devices

(76) Inventor: Dumitru Puiu, Sterling Heights, MI (US)

Correspondence Address: MAGNA INTERNATIONAL, INC., 337 MAGNA DRIVE, AURORA, ON, L4G-7K1, CA

(21) Appl. No.: 12/375,309

(22) PCT Filed: Jul. 26, 2007
(86) PCT No.: PCT/US07/16818

§ 371 Date: Jan. 27, 2009

Related U.S. Application Data
(60) Provisional application No. 60/834,673, filed on Jul. 31, 2006.

(51) Int. Cl. F16D 25/12

(52) U.S. Cl. 192/85 AA

(57) ABSTRACT

A power transfer device includes a shift collar moveable between a first position and a second position, a rotatable member, a rotary to linear movement conversion mechanism interconnecting the rotatable member and the shift collar, and a hydraulic actuator operable to drive the rotatable member. The actuator includes a vane rotatably moveable within a cavity formed in a housing and a pump selectively providing pressurized fluid acting on the vane. The vane is fixed for rotation with the rotatable member such that rotation of the vane causes the shift collar to axially translate.

### CROSS-REFERENCE TO RELATED APPLICATIONS

This application claims the benefit of U.S. Provisional Application No. 60/834,673, filed on Jul. 31, 2006. The disclosure of the above application is incorporated herein by reference.

### FIELD

The present disclosure relates to power transfer devices for use in motor vehicles and, more particularly, to a torque transmission mechanism equipped with a hydraulically-actuated shift system.

### BACKGROUND

The drivetrain in many light-duty and sport-utility vehicles includes a power transfer device, such as a transfer case, for transmitting drive torque to all four wheels of the vehicle, thereby establishing a four-wheel drive mode of operation. To accommodate differing road surfaces and conditions, some transfer cases are equipped with a gear reduction unit and a range shift mechanism that allow the vehicle operator to selectively shift between four-wheel high-range and low-range drive modes. In some instances, however, the vehicle must be stopped before the transfer case can be shifted between its four-wheel high-range and low-range drive modes. Specifically, transfer cases that are not equipped with “synchronized” range shift mechanism, require the vehicle to be stopped so as to allow the relative velocity between the gears being moved into meshed engagement to be reduced to an acceptable level (i.e., synchronized) before initiating the range shift. Attempting to perform a range shift without initially synchronizing the rotational speeds of the gears may cause undesirable noise as well as physical damage to the transfer case.

There may be instances, however, where stopping the vehicle to perform a range shift is inconvenient, particularly upon encountering road conditions and surface terrains where maintaining the vehicle's rolling momentum would assist in overcoming the adverse conditions encountered. To alleviate this problem, some transfer cases are adapted to permit the vehicle operator to shift between four-wheel high-range and low-range drive modes without having to stop the vehicle. One means for accomplishing this is by incorporating a device commonly known as a synchronizer into the range shift mechanism. The synchronizer temporarily prevents the rotating gears from entering into meshed engagement until their rotational velocities have been substantially equalized. Once the rotational velocities are substantially equal, the synchronized range shift mechanism allows the gears to enter into meshed engagement, thereby completing the range shift. However, a need exists to develop power transfer devices having automated shift systems for use in motor vehicles that advance the current technology.

### SUMMARY

In accordance with the present disclosure, a power transfer mechanism is described. The power transfer mechanism is equipped with a hydraulically-actuated shift system which includes a shift collar moveable between a first position and a second position, a rotatable member, a rotary to linear movement conversion mechanism interconnecting the rotatable member and the shift collar, and a hydraulic actuator operable to drive the rotatable member. The hydraulic actuator includes a vane rotatably moveable within a cavity formed in a housing and a pump selectively providing pressurized fluid to the cavity for causing controlled rotation of the vane. The vane is fixed for rotation with the rotatable member such that controlled bi-directional rotation of the vane within the cavity causes the shift collar to axially translate between its first and second positions.

Further areas of applicability of the present invention will become apparent from the detailed description provided hereinafter. It should be understood that the detailed description with specific examples, while indicating the preferred embodiment of the invention, are intended for purposes of illustration only and are not intended to limit the scope of the invention.

### DRAWINGS

The present invention will become more fully understood from the detailed description and the accompanying drawings, wherein:

FIG. 1 is an illustration of a drivetrain for a four-wheel drive motor vehicle equipped with a transfer case;

FIG. 2 is a sectional view of an exemplary transfer case equipped with a hydraulically-actuated range shift system;

FIG. 3 is a partial sectional view of the synchronized clutch assembly associated with the hydraulically-actuated range shift system shown in FIG. 2;

FIG. 4 is a schematic depicting a shift actuator mechanism associated with the hydraulically-actuated range shift system and which is constructed in accordance with the teachings of the present disclosure;

FIG. 5 is an enlarged portion of FIG. 2 showing the components of a rotary actuator associated with the shift actuator mechanism;

FIG. 6 is a sectional view of a shift actuator mechanism constructed in accordance with an alternate embodiment of the present invention;

FIG. 7 is another sectional view of the shift actuator mechanism shown in FIG. 6;

FIG. 8 is a sectional view of a shift actuator mechanism constructed in accordance with another alternate embodiment of the present invention; and

FIG. 9 is a sectional view of the shift actuator mechanism shown in FIG. 8.

### DETAILED DESCRIPTION OF THE PREFERRED EMBODIMENTS

The following description of the preferred embodiments is merely exemplary in nature and is in no way intended to limit the invention, its application, or uses.

In general, this invention relates to power transfer devices for use in motor vehicles having a hydraulically-actuated shift system for controlling shifting a clutch assembly in a torque transmission mechanism. The hydraulically-actuated shift system is operable for moving a clutch component of the clutch assembly between first and second positions. Although the present invention makes specific reference to a range shift system in a transfer case, it shall be appreciated that this invention is equally applicable to other gear shift mechanisms and applications. Accordingly, the detailed description section begins with a description of the components and operation of an exemplary transfer case.

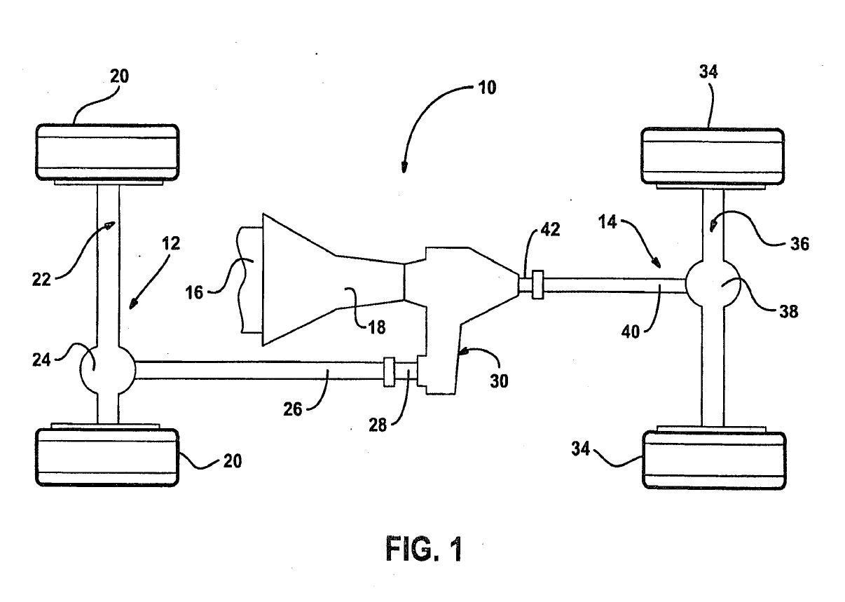

Referring to FIG. 1 of the drawings, a drivetrain 10 for a four-wheel drive vehicle is shown. Drivetrain 10 includes a front driveline 12 and a rear driveline 14. A power source, such as an engine 16 (partially shown), provides drive torque to the front and rear drivelines through a transmission 18. The transmission 18 may be either a manual or automatic shifting type. Front driveline 12 is shown to include a pair of front wheels 20 connected to opposite ends of a front axle assembly 22 having a front differential 24. Front differential 24 is coupled to one end of a front propshaft 26, the opposite end of which is coupled to a front output shaft 28 of a transfer case 30. Similarly, rear driveline 14 includes a pair of rear wheels 34 connected to opposite ends of a rear axle assembly 36 having a rear differential 38. Rear differential 38 is coupled to one end of a rear propshaft 40, the opposite end of which is coupled to a rear output shaft 42 of transfer case 30.

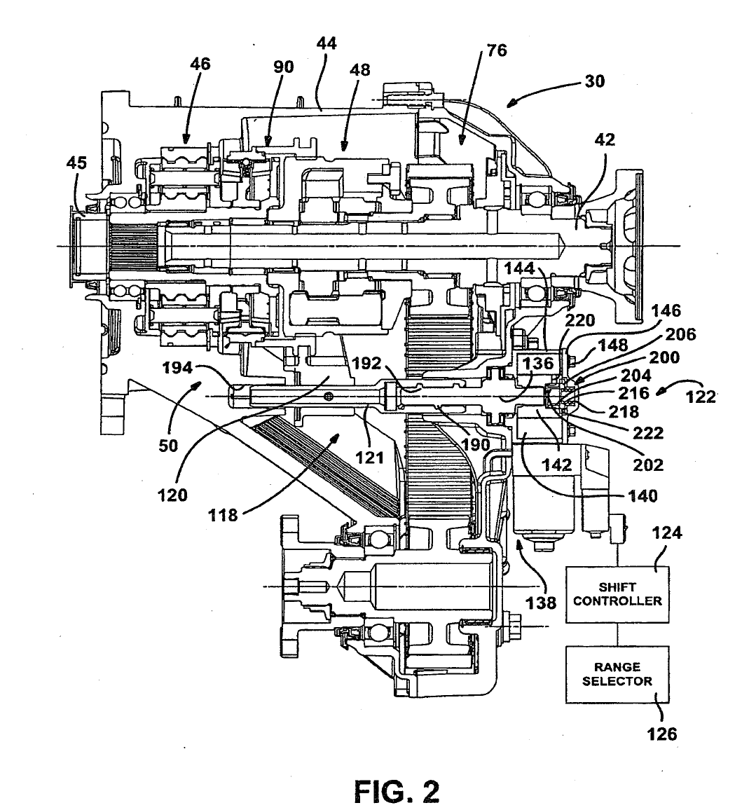

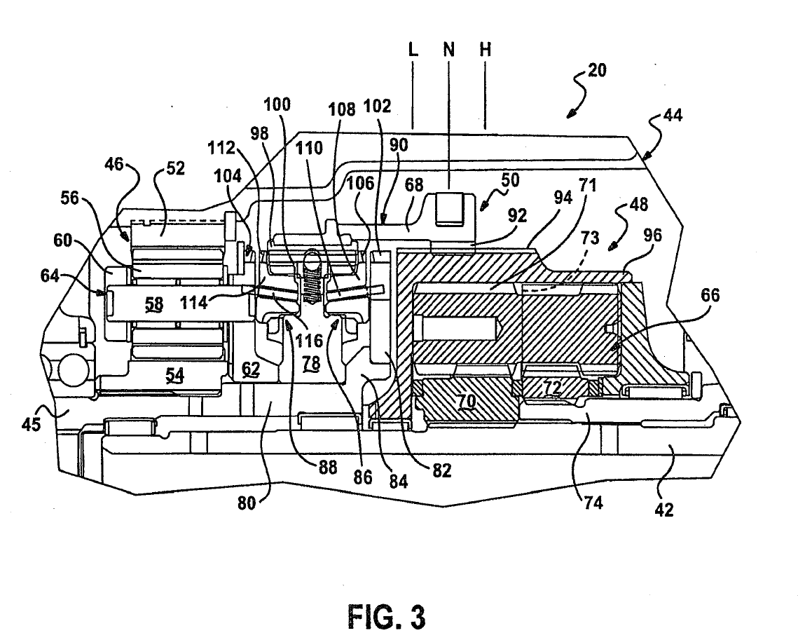

Referring primarily to FIGS. 2 and 3, transfer case 30 includes a housing assembly 44 and an input shaft 45 rotatably supported by housing assembly 44. Input shaft 45 is adapted for connection to an output shaft (not shown) of transmission 18, such that both are rotatably driven by engine 16. Transfer case 30 is also shown to include a planetary gear assembly 46, an interaxle differential 48, and a synchronized range shift mechanism 50.

As best seen from FIG. 3, planetary gear assembly 46 includes a ring gear 52 fixed to housing assembly 44 and a sun gear 54 fixed for rotation with input shaft 45. A set of pinion gears 56 are rotatably supported on a set of pinion shafts 58. Pinion gears 56 are meshed with sun gear 54 and ring gear 52. Each pinion shaft 58 extends between a front carrier ring 60 and a rear carrier ring 62 that are interconnected to define a planet carrier 64. Planetary gear assembly 46 is operable to cause planet carrier 64 to be driven at a reduced speed relative to sun gear 54 in response to rotation of input shaft 45.

Interaxle differential 48 functions to allow speed differentiation between front output shaft 28 and rear output shaft 42 of transfer case 30. Interaxle differential 48 includes a differential case 66 which is driven by a range sleeve 68 associated with range shift mechanism 50. Interaxle differential 48 includes two output components for directing torque from differential case 66 to the front and rear drive wheels 20 and 34 of the vehicle. Specifically, a first output sun gear 70 is meshed with rear output shaft 42 for transferring drive torque to rear wheels 34 of the vehicle. Similarly, a second output sun gear 72 is meshed with a transfer shaft 74 for transferring drive torque to front wheels 20 of the vehicle via a sprocket and chain transfer mechanism 76. Interaxle differential 48 also includes a gearset for transferring drive torque from differential case 66 to output sun gears 70 and 72 while facilitating speed differentiation therebetween. This gearset includes a plurality of meshed pairs of long pinions 71 and short pinions 73 supported within differential case 66. Long pinions 71 mesh with first output sun gear 70 while short pinions 73 mesh with second output sun gear 72.

With continued reference to FIG. 3, synchronized range shift mechanism 50 is shown to include a clutch hub 78 rotatably supported on a tubular segment 80 of input shaft 45, a clutch plate 82 fixed to an annular end segment 84 of input shaft 45, a first synchronizer assembly 86 disposed between clutch hub 78 and clutch plate 82, and a second synchronizer assembly 88 disposed between clutch hub 78 and rear carrier ring 62. Rear carrier ring 62 is shown journalled on tubular segment 80 of input shaft 45, with clutch hub 78 axially restrained between annular end segment 84 and rear carrier ring 62.

Synchronized range shift mechanism 50 also includes a range clutch 90, which is generally comprised of range sleeve 68 having a first set of internal teeth 92 that are maintained in constant mesh with a set of external teeth 94 formed on a drum portion 96 of differential case 66. Range sleeve 68 also includes a second set of internal teeth 98 which are maintained in constant mesh with a set of external teeth 100 formed on clutch hub 78. As such, range sleeve 68 is coupled for common rotation with drum 96 and clutch hub 78, but is permitted to slide axially in either direction.

Synchronized range shift mechanism 50 is operable to establish first and second drive connections between input shaft 45 and case 66 of interaxle differential 48. The first drive connection is established by range clutch 90 coupling-case 66 of interaxle differential 48 to clutch plate 82. This first drive connection defines a high-range drive mode in which interaxle differential 48 is driven at the same rotational speed as input shaft 45. The second drive connection is established by range clutch 90 coupling case 66 of interaxle differential 48 to rear carrier ring 62. This second drive connection defines a low-range drive mode in which interaxle differential 48 is driven at a rotational speed that is less than that of the input shaft 45. A non-driven neutral mode is established when range clutch 90 uncouples case 66 of interaxle differential 48 from both clutch plate 82 and rear carrier ring 62.

Synchronized range shift mechanism 50 is operable to allow transfer case 30 to be shifted between its high-range and low-range drive modes while the vehicle is in motion. This is accomplished by utilizing synchronizer assemblies 86 and 88 to synchronize the rotational speed of range clutch 90 with the rotational speed of clutch plate 82 or rear carrier ring 62 depending on the drive range the vehicle operator selects. With range clutch 90 in a neutral position (denoted by shift position N), clutch teeth 98 of range sleeve 68 are disengaged from meshed engagement with teeth 102 on clutch plate 82 and teeth 104 on rear carrier ring 62.

When it is desired to establish the high-range drive mode, range clutch 90 is slid axially toward a high-range position (denoted by shift position H). Initiation of a high-range shift actuates first synchronizer assembly 86, which is operable for causing speed synchronization between range clutch 90 and clutch plate 82. When the speed synchronization process first commences, external teeth 106 on a first blocker ring 108 are misaligned with teeth 98 of range sleeve 68. The misalignment prevents teeth 98 on range sleeve 68 from moving into meshed engagement with teeth 102 on clutch plate 82 until speed synchronization is achieved. Continued axial movement of range clutch 90 causes first blocker ring 108 to move axially toward clutch plate 82 and into frictional engagement with a first cone synchronizer 110 that is fixed for rotation with clutch plate 82. As is known, the frictional drag created by engaging first blocker ring 108 with cone synchronizer 110 creates a rotational torque that acts to decrease the rotational velocity of the faster moving part while increasing the rotational velocity of the slower moving part. This process continues until the rotational speed differential between range clutch 90 and clutch plate 82 is less than some determined value.

Once the speed synchronization process is completed, clutch teeth 98 on range sleeve 68 are permitted to move through teeth 106 of first blocker ring 108 and into meshed engagement with teeth 102 on clutch ring 82. With range sleeve 68 located in its H range position, drum 96 of interaxle differential 48 rotates at the same speed as input shaft 45. This connection establishes the first drive connection which, in turn, establishes a four-wheel high-range drive mode.

A four-wheel low-range drive-mode is established in a manner similar to that used to establish the four-wheel high-range drive mode. Continuing to refer to FIG. 3, a range shift from the high-range drive mode to the low-range drive mode is accomplished by sliding range sleeve 68 axially toward a low-range position (denoted by shift position L). Initiating a low-range shift actuates second synchronizer assembly 88 which is operable for causing speed synchronization between range clutch 90 and rear carrier ring 62. When the speed synchronization process first commences, external teeth 112 on a second blocker ring 114 are misaligned with teeth 98 of range sleeve 68. The misalignment prevents teeth 98 on range sleeve 68 from moving into meshed engagement with teeth 104 on rear carrier ring 62 until after speed synchronization is achieved. Continued axial movement of range sleeve 68 causes second blocker ring 114 to move axially toward rear carrier ring 62 and into frictional engagement with a second cone synchronizer 116 that is fixed for rotation with rear carrier ring 62. The frictional drag created by engaging second blocker ring 114 with second cone synchronizer 116 creates a rotational torque that acts to decrease the rotational velocity of the faster moving part while increasing the rotational velocity of the slower moving part. This process continues until the rotational speed differential between range sleeve 68 and rear carrier ring 62 is less than some determined value.

Once the speed synchronization process is completed, clutch teeth 98 on range sleeve 68 are permitted to move through teeth 112 of second blocker ring 114 and into meshed engagement with teeth 104 on rear carrier ring 62. With range clutch 90 situated in its L range position, drum 96 of interaxle differential 48 rotates at the same speed as planet carrier 64 rotates about sun gear 54 which, as mentioned, is at a reduced speed ratio relative to input shaft 45. This second drive connection establishes the four-wheel low-range drive mode.

Referring primarily to FIG. 2, movement of range sleeve 68 between its H, N, and L drive range positions is accomplished by means of a hydraulically-actuated shift system 118. Shift system 118 is comprised of a range fork 120 that is coupled to range sleeve 68, a shift rail 121, a shift actuator mechanism 122 for causing axial movement of range fork 120, a shift controller 124 for controlling operation of shift actuator mechanism 122, and a range selector 126 from which the vehicle operator can select a desired range shift.

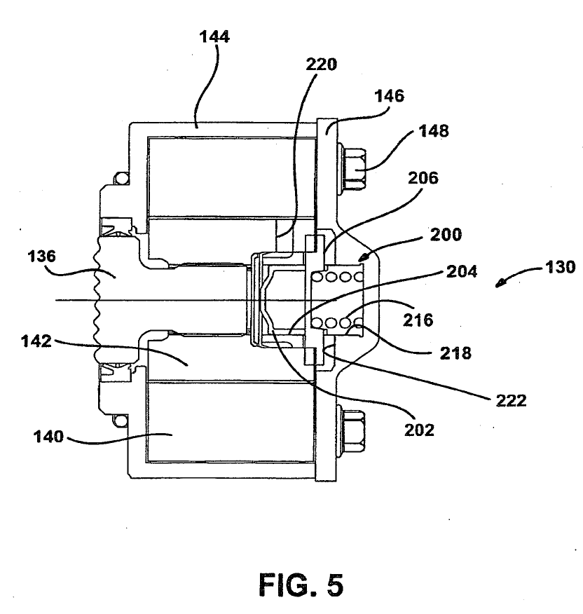

As best shown in FIGS. 2, 4 and 5, shift actuator mechanism 122 is comprised of a fluid pump 128, a rotary actuator 130, an electric motor 132, a shift valve 134, and a rotary output screw 136. Electric motor 132 is provided to drive fluid pump 128 and together they define an electrohydraulic power unit 138 that is secured to housing assembly 44. Rotary actuator 130 is shown to include a first or “reaction” ring 140 that is concentrically aligned with a second or “actuation” ring 142. The rings are retained within a chamber formed in an actuator housing 144 that is mounted to housing assembly 44. End plate 146 encloses reaction ring 140 and actuation ring 142 within actuator housing 144. A plurality of fasteners 148 couple end plate 146 and actuator housing 144 to housing assembly 44. Fasteners 148 pass through bores (not shown) in reaction ring 140 such that reaction ring 140 is non-rotatably fixed to actuator housing 144. Actuation ring 142 is in splined engagement with rotary output screw 136 such that actuation ring 142 and rotary output screw 136 are rotatable relative to reaction ring 140.

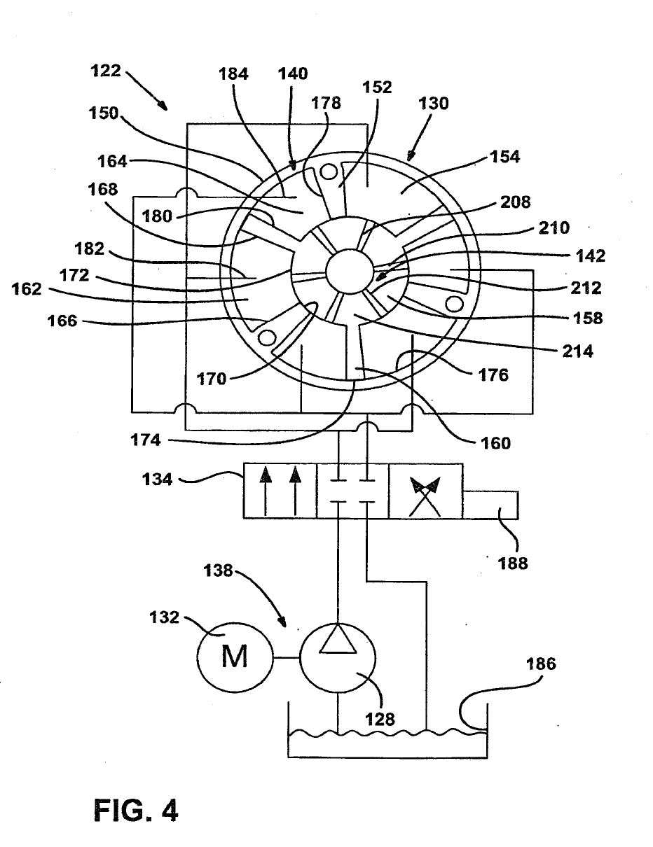

As best seen in FIG. 4, reaction ring 140 includes a cylindrical body segment 150 and a plurality of radially inwardly projecting lugs 152. Lugs 152 define a complimentary number of longitudinally extending channels 154. Actuation ring 142 has a cylindrical body segment 158 and a plurality of radially projecting lugs 160 extending outwardly from body segment 158. Each lug 160 extends into a corresponding one of channels 154 so as to define sets of first and second actuation chambers 162 and 164 on opposite sides of lugs 160. First actuation chambers 162 are delimited by a face surface 166 of lugs 152 and a face surface 168 of lugs 160. A distal end surface 170 on each lug 152 is in sliding engagement with an inner wall surface 172 of body segment 158 while a distal end surface 174 on each lug 160 is in sliding engagement with an outer wall surface 176 of body segment 150 so as to further delimit each actuation chamber 162. Second actuation chambers 164 are defined by an opposite face surface 178 of lugs 152 and an opposite face surface 180 of lugs 160. A first set of ports 182 extend through reaction ring 140 and communicate with first actuation chambers 162. Likewise, a second set of ports 184 enter through reaction ring 140 and communicate with second actuation chambers 164.

FIG. 4 also depicts fluid pump 128 being operable to draw fluid from a sump 186 and provide pressurized fluid to shift valve 134. Shift valve 134 is shown as a three-position, four-way valve that is selectively positionable in one of the three valve positions by a solenoid 188. The leftmost valve position provides pressurized fluid to first ports 182. When pressurized fluid is present within first actuation chambers 162, actuation ring 142 rotates in a first direction. Concurrently, fluid located within second actuation chambers 164 is discharged into sump 186. Another porting arrangement exists at the opposite end position of shift valve 134. In this position, pressurized fluid is supplied to second actuation chambers 164 while the fluid within first actuation chambers 162 is discharged to sump 186. Accordingly, actuation ring 142 rotates in an opposite direction when pressurized fluid is delivered to second actuation chambers 164. A middle position of shift valve 134 closes first ports 182 and second ports 184. In this central valve position, the rotational position of actuation ring 142 is maintained at its present location.

As previously mentioned, body segment 158 of actuation ring 142 is fixed via a spline connection to rotary output screw 136. External threads 190 are formed on rotary output screw 136. External threads 176 are in meshed engagement with a set of internal threads 192 formed in one end of shift rail 121. Another end of shift rail 121 is supported in a housing socket 194. Range fork 120 is fixed to shift rail 121 such that bi-directional rotation of output screw 136 caused by actuating rotary actuator 130 results in bi-directional axial translation of shift rail 121 and range fork 120 which, in turn, causes range clutch 90 to move between its three distinct range positions. Thus, the threaded engagement of output screw 136 with shift rail 121 defines a rotary to linear conversion mechanism operable to convert the rotary output of rotary operator 130 into linear movement of range sleeve 68.

Shift actuator mechanism 122 also includes a locking mechanism 200 that is operable to selectively restrict rotation of actuation ring 142 relative to reaction ring 140. Locking mechanism 200 includes a piston 202 axially moveable within a cavity 204 formed within actuator housing 144. A locking pin 206 is fixed to piston 202 and transversely extends therethrough. Actuation ring 142 includes first, second and third radially extending grooves 208, 210, and 212 formed in a face 214 of actuation ring 142. A spring 216 is located within a pocket 218 formed within end plate 146. Spring 216 biases locking pin 206 toward face 214 of actuation ring 142. When pressurized fluid is not provided by electrohydraulic power unit 138, locking pin 206 is biased by spring 216 into engagement with one of radially extending grooves 208, 210 and 212 to restrict rotation of actuation ring 142 relative to reaction ring 140, thereby maintaining the position of range sleeve 68 in one of the H, N, or L positions.

During operation of shift system 118, shift controller 124 controls the operation of electrohydraulic power unit 138. Shift controller 124 includes a central processing unit (CPU) that executes a control algorithm stored in the shift controller's memory. Shift controller 124 also controls actuation of shift valve 134 in response to a control signal received from range selector 126. Shift controller 124 provides control signals to solenoid 188 to position shift valve 134 at a desired shift valve position. If shift valve 134 is in one of its end positions, pressurized fluid is provided to rotary actuator 130. Rotary actuator 130 includes a fluid passageway 220 which places piston 202 in communication with the pressurized fluid when one of grooves 208, 210 or 212 is aligned with locking pin 206. As pressurized fluid acts on piston 202, locking pin 206 is axially translated out of one of grooves 208, 210, and 212 and into a recess 222 formed within end plate 146. Once locking pin 206 is axially displaced from grooves 208, 210 and 212, actuation ring 142 is free to rotate relative to reaction ring 140. If a loss of pressurized fluid supply to rotary actuator 130 occurs, spring 216 biases locking pin 206 within one of grooves 208, 210, and 212 to maintain the current position of actuation ring 142, rotary output screw 136, shift rail 121, range fork 120, and range sleeve 68.

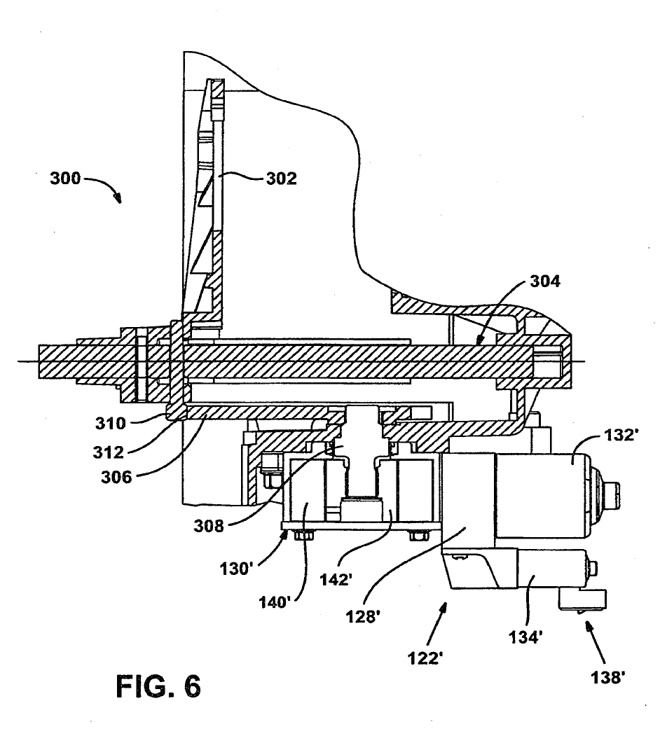

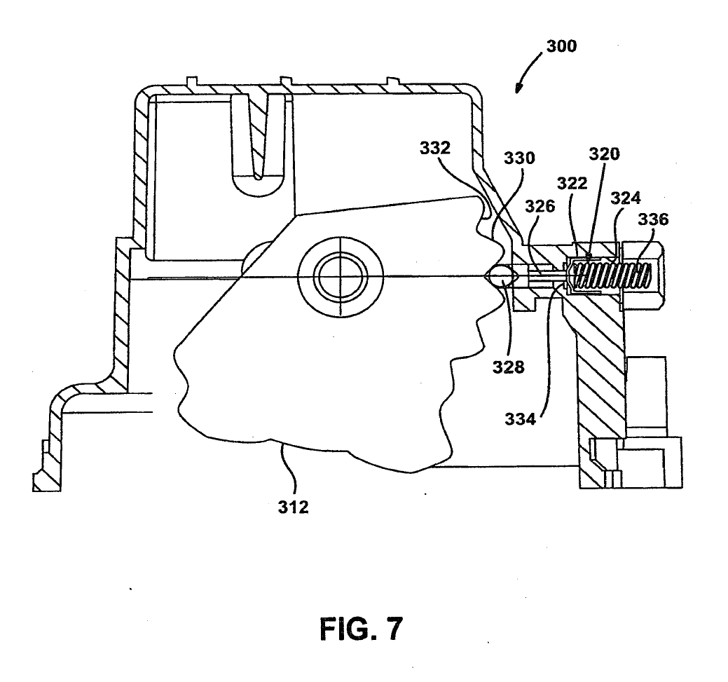

FIGS. 6 and 7 depict an alternate embodiment for a hydraulically-actuated shift system 300 including a range fork 302 fixed to a shift rail 304. Range fork 302 engages range sleeve 68 in similar fashion to range fork 120 previously described. A sector plate 306 is fixed for rotation with a rotary output shaft 308. A follower 310 is fixed to shift rail 304 and is in biased engagement with a cam surface 312 formed on sector plate 306. A shift actuator mechanism 122′ is substantially similar to shift actuator mechanism 122 previously described. Accordingly, a detailed description of range shift actuator 122′ will not be provided and like elements will retain their previously introduced reference numerals having a “prime” suffix. As seen, actuation ring 142′ of rotary actuator 130′ is splined to output shaft 308. As such, rotation of actuation ring 142′ relative to reaction ring 140′ causes rotation of sector plate 306 which, in turn, axially translates shift rail 304 and shift fork 302 due to the cam profile of cam surface 312. Thus, this arrangement defines another rotary to linear conversion mechanism for use with the present invention.

A locking mechanism 320 is operable to selectively restrict the rotation of sector plate 306 under certain operating conditions. Locking mechanism 320 includes a piston 322 slidably positioned within a bore 324. A follower 326 is fixed to piston 322 and includes a ball 328 in biased engagement with a second cam surface 330 formed on sector plate 306. Cam surface 330 defines a plurality of detents 332 within which ball 328 may seat. The rotary positions of detents 332 correspond to the L, N, and H axial positions of range sleeve 68.

Pressurized fluid provided by electrohydraulic power unit 138 is in communication with piston 322 via a port 334. When magnitude of the fluid pressure is sufficient to overcome the biasing force of a spring 336, follower 326 moves away from cam surface 330 such that ball 328 is withdrawn from detents 332 thereby allowing sector plate 306 to rotate. Should pressurized fluid no longer be supplied to rotary actuator 130′, spring 336 forces ball 328 into one of detents 332 to maintain the rotary position of sector plate 306. In turn, range sleeve 68 is also restricted from movement and the present range gear selection will be maintained.

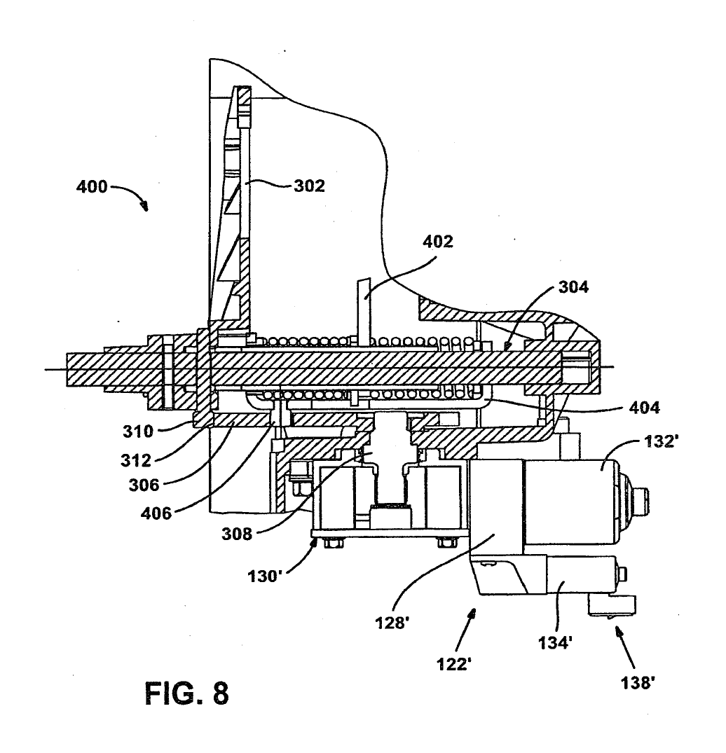

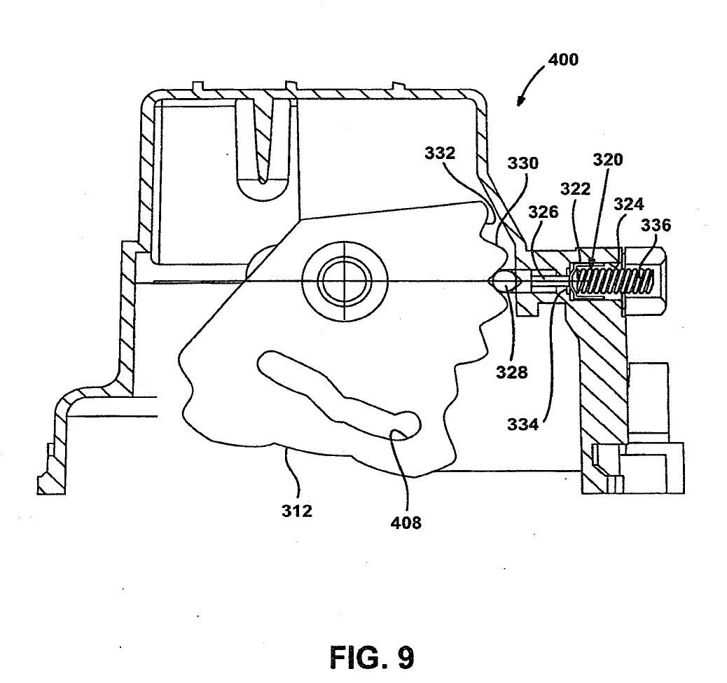

FIGS. 8 and 9 depict an alternate for an embodiment hydraulically-actuated range shift system 400. Shift system 400 is substantially similar to shift system 300 except that a mode shift subassembly has been added. Accordingly, like elements will retain their previously introduced reference numerals. Shift system 400 includes a mode shift fork 402 fixed to a carrier 404 that is supported by and is axially moveable relative to shift rail 304. Mode shift fork 402 is coupled to a mode clutch (not shown) that is operable to shift the operating mode of transfer case 30 between full-time and locked four-wheel drive modes. A second follower 406 includes one end fixed to carrier 404. An opposite end of the second follower 406 is positioned within a cam groove 408 formed within sector plate 306. Groove 408 is sized and shaped such that bi-directional rotational movement of sector plate 306 causes bi-directional axial movement of follower 406 and mode fork 402. In this manner, a single rotary actuator 122′ may be used to not only affect a range shift between low, neutral, and high settings but also affect a mode shift between different four-wheel drive operational modes.

As understood, the present invention relates to a hydraulically-actuated shift system of the type well-suited for use in any power transfer device equipped with a torque transmission mechanism having a clutch assembly with a clutch component moveable between at least two distinct positions. Thus, use of the hydraulically-actuated shift system of the present invention finds particular application with a gearshift clutch in automated manual transmissions, with a locking clutch in a locking differential in transfer cases or axles, and with a range or mode clutch in transfer cases and power take-off units. Accordingly, the use of a hydraulically-controlled rotary actuator for driving a conversion unit which converts the rotary output of the rotary actuator into axial translation of the clutch component is a feature of the present invention.

Furthermore, the foregoing discussion discloses and describes merely exemplary embodiments of the present invention. One skilled in the art will readily recognize from such discussion, and from the accompanying drawings and claims, that various changes, modifications and variations may be made therein without department from the spirit and scope of the invention as defined in the following claims.

What is claimed is:

1. A power transfer device comprising:
a clutch having a shift component moveable between a first position and a second position;
a rotatable member;
a rotary to linear movement conversion mechanism interconnecting said rotatable member and said shift component; and
a shift actuator mechanism operable to drive said rotatable member, said shift actuator mechanism including a pump and an actuation ring rotatably coupled to a reaction ring, said pump selectively providing pressurized fluid which acts on said actuation ring to cause said actuation ring to rotate, said actuation ring being fixed for rotation with said rotatable member such that rotation of said actuation ring causes said shift component to axially translate.

2. The power transfer device of claim 1 wherein said reaction ring and said actuation ring cooperate to define first and second actuation chambers, wherein said pump is operable to selectively provide pressurized fluid to said first actuation chambers to rotate said actuation ring in a first direction and provide pressurized fluid to said second actuation chambers to rotate said actuation ring in a second direction opposite to said first direction.

3. The power transfer device of claim 2 wherein said first and second actuation chambers are defined by a first set of lugs radially extending from said actuation ring which are interleaved with a second set of lugs radially extending from said reaction ring.

4. The power transfer device of claim 2 wherein said actuation ring rotates relative to said reaction ring a predetermined angular amount such that said shift component translates a predetermined distance.

5. The power transfer device of claim 4 wherein said predetermined angular amount is less than 360 degrees.

6. The power transfer device of claim 2 wherein bi-directional movement of said actuation ring provides bi-directional movement of the shift component.

7. The power transfer device of claim 2 further including a valve operable in a first mode to selectively supply pressurized fluid from said pump to one of said first and second actuation chambers and interconnect a sump with the other of said first and second actuation chambers.

8. The power transfer device of claim 1 wherein said shift actuator mechanism further includes a locking mechanism operable to restrict rotation of said actuation ring if pressurized fluid is no longer provided by said pump.

9. The power transfer device of claim 8 wherein said locking mechanism includes a pin selectively moveable between a position within a locking aperture formed in said actuation member and a position clear of said locking aperture, said pin being operable to restrict rotation of said actuation member when positioned within said locking aperture.

10. The power transfer device of claim 9 further including a piston coupled to said pin wherein the pressurized fluid provided by said pump acts on said piston to position said pin clear of said locking aperture when said shift component is in one of said first and second positions.

11. The power transfer device of claim 10 wherein the supply of pressurized fluid to said piston is discontinued when said shift component is located between its first and second positions.

12. The power transfer device of claim 11 wherein said pin is biased toward said locking aperture.

13. The power transfer device of claim 9 further including a second locking aperture formed in said actuation member wherein a position of one of said locking apertures corresponds to said shift component being at its first position, said other locking aperture position corresponding to said shift component being in its second position, such that upon discontinuation of a supply of pressurized fluid from said pump said shift component will be restricted to one of its first and second positions.

14. The power transfer device of claim 1 wherein said rotary to linear movement conversion mechanism includes an axially translatable member threadingly engaged with said rotatable member.

15. The power transfer device of claim 14 wherein said rotatable member is a shaft having an external thread.

16. The power transfer device of claim 15 wherein said axially translatable member is a shift rail fixed to said shift component, said shift rail including an internal thread drivingly engaging said external thread, said shaft drivingly engaging said actuation ring.

17. The power transfer device of claim 1 wherein said rotary to linear movement conversion mechanism includes an axially translatable member following a cam surface formed on said rotatable member.

18. The power transfer device of claim 17 wherein said rotatable member is a sector plate having a slot extending therethrough, said slot being defined at least in part by said cam surface.

19. The power transfer device of claim 18 wherein said axially translatable member is a cam follower fixed to said shift component.

20. The power transfer device of claim 19 further including a second axially translatable member following another cam surface formed on said rotatable member.

21. A power transfer device, comprising:
a rotary input member;
a rotary output member;
a torque transmission mechanism disposed between said input member and said output member;
a clutch operable in a first position to release said output member from engagement with said input member and in a second position to couple said output member to said input member;
a rotatable member;
a rotary to linear movement conversion mechanism coupling said rotatable member to said clutch; and
a shift actuation mechanism operable to rotatably drive said rotatable member and including a vane rotatably disposed within a cavity formed in a housing and a pump selectively providing pressurized fluid acting on said vane, wherein said vane is fixed to said rotatable member such that rotation of said vane in response to fluid pressurized exerted thereon causes said rotary to linear movement conversion mechanism to convert rotation of said rotatable member into linear movement of said clutch between its first and second positions.

22. The power transfer device of claim 21 wherein said torque transmission mechanism is a speed reduction unit having an input component driven by said input member and an output component driven at a reduced speed relative to said input component, and wherein said clutch is operable in its first position to couple said output member to said input component of said speed reduction unit and is operable in its second position to couple said output member to said output component of said speed reduction unit.

23. The power transfer device of claim 22 wherein said clutch includes a sleeve secured for common rotation with said output member and axial movement thereon between its first and second positions.

24. A power transfer device comprising:
a rotary input member;
a rotary output member;
a gearset having first, second and third gear members;
a shift sleeve axially moveable between a first position where said first and second gear members are coupled for rotation with one another such that said rotary output member is driven by said rotary input member at a first speed ratio and a second position where said second and third gear members are coupled for rotation with one another such that said rotary output member is driven by said rotary input member at a second speed ratio;
a rotatable member;
a rotary to linear movement conversion mechanism coupled to said rotatable member and said sleeve; and
an actuator operable to drive said rotatable member, said actuator including a vane rotatably moveable within a cavity formed in a housing and a pump selectively providing pressurized fluid acting on said vane, wherein said vane is fixed for rotation with said rotatable member such that rotation of said vane causes said sleeve to axially translate.

25. The power transfer device of claim 24 wherein said vane radially extends from a hub rotatably supported by said housing.

26. The power transfer device of claim 25 wherein said housing includes a plurality of cavities in receipt of a plurality of vanes extending from said hub.

27. The power transfer device of claim 23 wherein said cavities are at least partially defined by radially inwardly extending walls.

28. The power transfer device of claim 24 wherein each cavity includes a substantially cylindrically-shaped wall positioned between two radially inwardly extending walls.

29. The power transfer device of claim 25 wherein each radially inwardly extending wall terminates adjacent said hub.

30. The power transfer mechanism of claim 24 further including a valve operable to selectively direct pressurized fluid to opposite first and second sides of said vane to selectively rotate said vane bi-directionally.

31. The power transfer device of claim 24 wherein said rotary to linear movement conversion mechanism includes an externally threaded member engaging an internally threaded member.

32. The power transfer device of claim 24 wherein said rotary to linear movement conversion mechanism includes a linearly moveable follower engaging a cam surface of a rotatable cam plate.

33. A power transfer device comprising:
a shift collar moveable between a first position and a second position;
a rotatable member;
a rotary to linear movement conversion mechanism operable to linearly drive said shift collar in response to rotation of said rotatable member;
an actuator operable to drive said rotatable member, said actuator including a vane rotatably moveable within a cavity formed in a housing and a pump selectively providing pressurized fluid acting on said vane wherein said vane is fixed for rotation with said rotatable member such that rotation of said vane causes said shift collar to axially translate; and
a locking mechanism operable to restrict rotation of said vane if pressurized fluid is no longer provided by said pump.

34. The power transfer device of claim 33 wherein said locking mechanism includes a pin selectively moveable between a position within a slot formed in said vane and a position clear of said slot, said pin being operable to restrict rotation of said vane when positioned within said slot.

35. The power transfer device of claim 34 further including a piston coupled to said pin wherein pressurized fluid provided by said pump acts on said piston to position said pin clear of said slot when said shift collar is in one of its first and second positions.
